(19) United States
(12) Patent Application Publication
(10) Pub. No.: US 2022/0128986 A1
(43) Pub. Date: Apr. 28, 2022

(54) Method And Systems For Facilitating Operator Concentration On One Among A Plurality Of Operator Workstation Screens

(71) Applicant: ABB Schweiz AG, Baden (CH)

(72) Inventor: Veronika Domova, Västerås (SE)

(21) Appl. No.: 17/423,176

(22) PCT Filed: Jan. 29, 2019
(86) PCT No.: PCT/EP2019/052062

§ 371 Date: Jul. 15, 2021

(51) Int. Cl. G05B 23/02; G05B 19/406

(52) U.S. Cl. CPC G05B 23/0272; G05B 23/0216; G05B 2219/31469; G05B 19/406; G05B 2219/34493; G05B 23/027

(57) ABSTRACT

A method of facilitating operator concentration on one among a plurality of operator workstation screens of a control and monitoring system, wherein the method is performed by the control and monitoring system and includes: detecting which of the plurality of screens that an operator is focused on, where the screen on which the operator is focused is a first screen, displaying information on the first screen in a focal display state with a high degree of detail, and displaying information on at least a second screen, which is different from the first screen, in a peripheral display state with a lower degree of detail than the focal display state.

### TECHNICAL FIELD

The present disclosure relates to a method and systems for facilitating operator concentration on one among a plurality of operator workstation screens in a control and monitoring system.

### BACKGROUND

In a control room of a plant, such as an industrial plant in which an industrial process being controlled by a process control system is monitored, a typical operator workstation can comprise many operator workstation screens of different sizes and purposes. For example, a workstation including the ABB® 800xA system may comprise nine operator workstation screens of different sizes.

A person physically cannot look at all the screens at the same time. The user is normally working with one or several screens which are in his/her focal (a.k.a. central) area, i.e. in front of the eyes. Other screens are in the peripheral area of the user's sight. Peripheral vision belongs to the visceral level of perception, triggering unconscious or emotional reactions that are more instinctive in nature. For instance, imagine a stone age hunter who notices motion in the periphery which could potentially be a hidden threat, e.g. a snake. The hunter would instinctively freeze which is the most natural reaction in case of a threat. Peripheral vision plays an essential role in comprehending visual information and getting the essence of what's around us.

Central vision can comprehend a high level of detail, but peripheral vision is blurry, it is weak in humans, especially at distinguishing detail, color, and shape. The periphery has a relative advantage at processing simple objects, noticing flicker, distinguish grayscale, and is also relatively good at detecting motion. Against this background, when on the peripheral sight, the information displayed on a screen in an ordinary display mode cannot be fully taken in by the user.
As can be seen above, there are many screens an operator must monitor. At any time, the operator can focus only on one screen. Other screens remain in the peripheral sight of the operator. The information presented on such screens in its current form is not very informative to the operator.
The process graphics on modern screens is typically tailored only to the focal sight of the human, i.e. it is overloaded with details.

This is uneconomical in that information that cannot be used is being displayed.

The situation is additionally potentially problematic in that an operator of a process control system, which may need to focus on a certain screen in his or her central view, may be distracted by information that is displayed on a screen in the peripheral view.

In the article “Perifoveal display: combining foveal and peripheral vision in one visualization”, by Valentin Heun, Anette von Kapri and Pattie Maes in Proceedings of the 2012 ACM Conference on Ubiquitous Computing, Pages 1150-1155, Pittsburgh, Pa.—Sep. 5-8, 2012, there is described a so-called Perifoveal Display that may be of use in industrial plants. In such a display more details are shown in the area that a user focuses on and less details are shown in the periphery of the view. Moreover, in such a display two GUIs fade seamlessly into each other.

However, there is still room for improvement, especially when used in a control and monitoring system for a process control system.

### SUMMARY

In view of the above, an object of the present disclosure is to provide a method and systems for solving or at least mitigating the above-discussed problems.

There is hence according to a first aspect of the present disclosure provided a method of facilitating operator concentration on one of a plurality of operator workstation screens of a control and monitoring system. The method is performed by the control and monitoring system and comprises:
detecting which of the plurality of screens that an operator is focused on, where the screen on which the operator is focused is a first screen,
displaying information on the first screen in a focal display state with a high degree of detail, and
displaying information on at least a second screen, which is different from the first screen, in a peripheral display state with a lower degree of detail than the focal display state.

There is according to a second aspect of the present disclosure a computer program comprising computer code which when executed by processing circuitry (3) of a control and monitoring system (1) causes the control and monitoring system (1) to perform the steps of the method according to the first aspect.

The computer code may more particularly cause the control and monitoring system to:
detect which of the plurality of screens that an operator is focused on, where the screen on which the operator is focused is a first screen,
display information on the first screen in a focal display state with a high degree of detail, and
display information on at least a second screen, which is different from the first screen, in a peripheral display state with a lower degree of detail than the focal display state.

There is according to a third aspect of the present disclosure a control and monitoring system comprising:
a plurality of operator workstation screens,
a storage medium (5) comprising computer code,
a head orientation determining system, and
processing circuitry (3) which when executing the computer code causes the control and monitoring system (1) to perform the steps of the method as claimed in the first aspect.

The processing circuitry may more particularly be configured to
detect which of the plurality of screens that an operator is focused on, where the screen on which the operator is focused is a first screen,
display information on the first screen in a focal display state with a high degree of detail, and
display information on at least a second screen, which is different from the first screen, in a peripheral display state with a lower degree of detail than the focal display state.

A first variation of the above-mentioned aspects involves detecting a change of focus by the operator from the first screen to the second screen, where the first screen initially has the focal display state and the second screen initially has the peripheral display state, changing the state of the second screen from the peripheral display state to the focal display state based on the detection of change of focus and changing the state of the first screen from the focal display state to the peripheral display state based on the detection of change of focus.

In a second variation of the above-mentioned aspects the changing of the state of the second screen from the peripheral display state to the focal display state is made directly after the detection of change of focus and the changing of the state of the first screen from the focal display state to the peripheral display state is made gradually after the detection of change of focus.

According to a third variation the gradual change is finished within a time in a range of 20-90 s, and with advantage in a range of 30-60 s, after being initiated.

According to a fourth variation an object displayed in a first area of the second screen is a process control object for which alarms can be generated, and further comprising displaying, upon the generation of an alarm for the object when the second screen has the peripheral display state, a visual indicator of the alarm in a second area of the second screen adjacent the first screen, detecting the change of focus from the first to the second screen and moving the indicator of the alarm to the corresponding object displayed in the first area of the second screen after the detection of change of focus.

According to a fifth variation the moving of the indicator comprises gradually moving the visual indicator of the alarm across the second screen from the second area to the first area.

According to a sixth variation the indicator is initially displayed in the first area of the second screen and moved to the second area for the displaying.

The focal display state and peripheral display state may be employed when the control and monitoring system is operating in a focus display mode.

A seventh variation of the aspects involves detecting movements of the operator, analysing user data comprising data of operator movements, determining that the user is focusing on a screen based on the analysis and entering the focus display mode based on the analysis, in which focus display mode the screen that the user focuses on has the focal display state and at least one other screen has the peripheral display state.

According to an eighth variation there is a detection of the time during which movements are made in the direction towards the first screen and the analysing comprises analysing the detected time.

According to a ninth variation there is a detection of movement of a user interface device and the analysing comprises analysing the detected user interface device movement.

The detected movements of the operator may be head movements.

According to a tenth variation there is a detection of the distance between the operator and at least one of the plurality of operator workstation screens and the analysing comprises analysing also the detected distance.

Moreover, the displaying in the focal display state comprises displaying using a set of colours and the displaying in the peripheral display state comprises displaying using grey scale.

As an alternative the displaying in the focal display state comprises displaying using a first colour scale and the displaying in the peripheral display state comprises displaying using a second colour scale.

The invention has a number of advantages. It allows an operator to concentrate on a task without being unnecessarily disturbed by what is displayed in his or her peripheral view. The provision of the view used in a peripheral display state may be implemented in a simple fashion without changing the displaying functionality used in the regular display mode.

Generally, all terms used in the claims are to be interpreted according to their ordinary meaning in the technical field, unless explicitly defined otherwise herein. All references to “a/an/the element, apparatus, component, means, etc.” are to be interpreted openly as referring to at least one instance of the element, apparatus, component, means, etc., unless explicitly stated otherwise. Moreover, any step in a method need not necessarily have to be carried out in the presented order, unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows a control and monitoring system including a perspective view of an operator workstation comprising a first, a second and a third screen, where the first screen operates in a focal display state and the second and third operate in a peripheral display state;

FIG. 2 schematically shows an operator focusing on one of the operator screens;

FIG. 3 shows a flow chart of a number of method steps used for entering into a focus display mode;

FIG. 4 is a flow chart of a number of method steps in the focus display mode for determining which screen is to operate in a focal display state and which screens are to operate in a peripheral display state,

FIGS. 5a and 5b schematically shows the movement of an alarm indicator between a first area and a second area of the second screen when operating in the peripheral and the focal display states,

FIG. 6 is a flow chart of a number of method steps in the focus display mode for the displaying of the alarm representation in the second screen;

FIG. 7 is a flow chart of a number of method steps in the focus display mode for changing the first screen to operating in the peripheral display state and changing the second screen to operating in the focal display state, and

FIG. 8 schematically shows the gradual change of the first screen when switching to operate in the peripheral display state.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

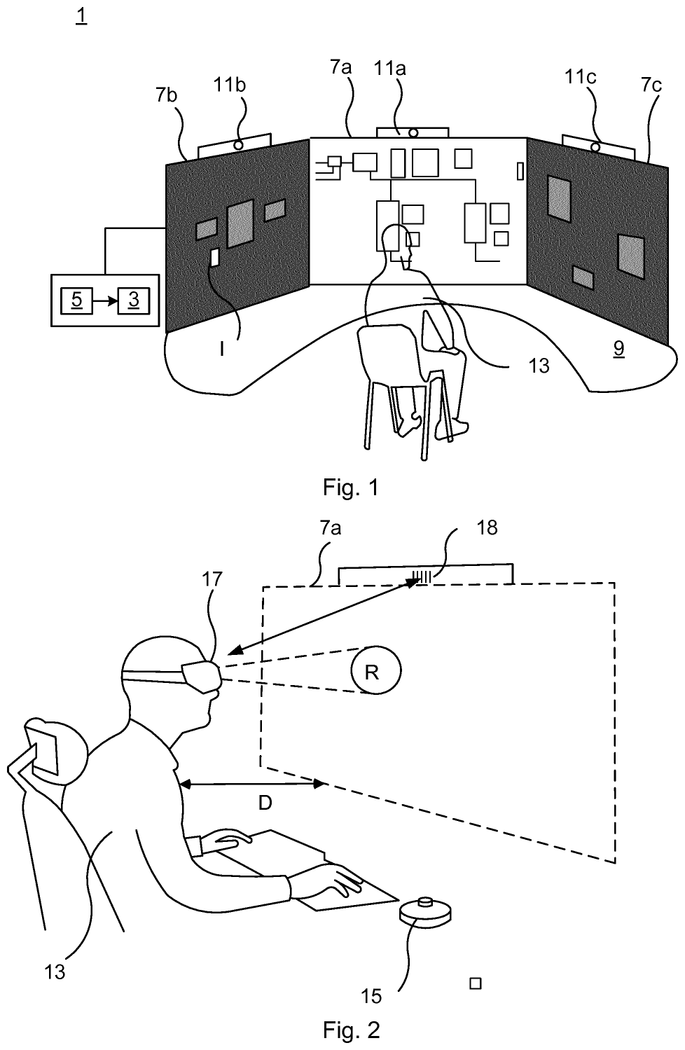

FIG. 1 depicts a control and monitoring system 1. The exemplified control and monitoring system 1 is a process control and monitoring control system configured to monitor and control an industrial process or a portion thereof.

The control and monitoring system 1 comprises processing circuitry 3 and a storage medium 5. The storage medium 5 comprises computer code which when executed by the processing circuitry 3 causes the control and monitoring system 1 to perform the methods disclosed herein. It more particularly comprises computer code causing the control and monitoring system to implement a display control unit performing a display control function used for entering a focal display mode and the controlling of screens to switch between focal and peripheral display states in the focal display mode.

The processing circuitry 3 uses any combination of one or more of a suitable central processing unit (CPU), multiprocessor, microcontroller, programmable logic controller (PLC), digital signal processor (DSP), application specific integrated circuit (ASIC), field programmable gate arrays (FPGA) etc., capable of executing any herein disclosed operations concerning facilitating operator concentration on one of a plurality of workstation screens.

The storage medium 5 may for example be embodied as a memory, such as a random-access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory.

The control and monitoring system 1 also comprises a plurality of operator workstation screens 7a-7c. The operator workstation screens 7a-7c are configured to communicate with the processing circuitry 3. The operator workstation screens 7a-7c are configured to display process graphics. Each operator workstation 7a-7c may be configured to display distinct process graphics with respect to the process graphics displayed on the other operator workstation screens 7a-7c. The process graphics are related to the underlying industrial process of which a part is generally outlined in one of the screens (not shown in FIG. 1) which the control and monitoring system 1 is configured to monitor and control.

The operator workstations screens 7a-7c form part of an operator workstation 7. The operator workstation 7 may for example include a desk 9 onto which the operator workstation screens 7a-7c are mounted. A single operator 13 may have as working task to monitor all of the operator workstation screens 7a-7c of the operator workstation 7 in order to overview the operation of the process control system.

In this situation the system operator 13 normally has one screen in his or her central or focal view and one or more in his or her peripheral view.

Central vision can comprehend a high level of detail, but peripheral vision is blurry, it is weak in humans, especially at distinguishing detail, colour, and shape. The periphery has a relative advantage at processing simple objects, noticing flicker, distinguish grayscale, and is also relatively good at detecting motion. For instance, astronomers have developed the so-called averted vision, see https://en.wikipedia.org/wiki/Averted_vision, i.e. they are looking not directly at stars but slightly off to the side of them which results in a better distinction of the stars.

The displaying of process graphics is typically not adapted to this functionality of the human eye.
The process graphics on all the screens is today typically tailored only to the focal sight of the human, i.e. it is overloaded with details, shown in colour, the shapes are detailed, lots of numerical and textual labels, etc. When in the peripheral sight, this information representation is not efficient, i.e. the user cannot retrieve any information unless he/she looks at the screen.

Against this background, the process control information depicted on screens in the peripheral view of the operator 13 is not giving much information to him or her.

In order to address this it is possible to have different display modes where one screen is a focal screen and at least one of the others is a peripheral screen. The focal screen is then operating in a focal display state where details of processor graphics and full colours are used, while peripheral screens that are in peripheral view are operating in a peripheral display state where less detail and other colours may be used. It is for instance possible that the focal display state comprises displaying using a set of colours and the displaying in the peripheral display state comprises using grey scale. This means that the change may also be a change in which a first set of colours are used in the focal display state and a second set of colours are used in the peripheral display state, where the first set differs from the second set.

The idea is thus to track which screens of the workstation are in the focal area of the operator's sight and which are in the periphery. The process graphics of the identified peripheral screens may then switch to the peripheral display state, i.e. are adjusted for the peripheral vision of the operator. One way in which the switching may be performed is as follows:
1. switch the graphics to grey scale or a different set of colours compared with the colours of the focal display state
2. simplify the shapes into primitives, e.g. circles, rectangles or dots
3. show alarms and notifications as flicking (increasing/decreasing the brightness of white color) and motion of the primate shapes

Each process graphics view should therefore have two representations, one ordinary (i.e. fully detailed and in colour) when the view is in the focal sight and one simplified, for instance in grey scale, when the view is in the peripheral sight of the user.

The transition between the process graphics representation from focal to peripheral may additionally be implemented in a soft manner, e.g. through slow fading of the colored and detailed process graphics into simplified gray scale. On the contrary, when the screen gets the attention, the switch should be immediate.

Particular design approach how a process graphics view should look in the peripheral mode can vary from implementation to implementation. However, some ideas are the following:
1. Simplify the shapes. Omit the details. Remove texts and numbers.
2. Keep the view in gray scale. The darker the objects are the less attention they attract, the brighter the objects are the more visible they are.
3. Attract the operator's attention using flickering (i.e. changing the brightness of the object from gray to white) or by motion, e.g. moving the object closer towards the focal area of the user.

FIG. 1 also schematically shows the use of focal and peripheral display states for the operator 13 of the process control system. In the example of FIG. 1, the operator is looking at a central first screen 7a, which is in a focal display state with the full details of a part of the process control system being associated with the first screen 7a, perhaps also in full colours. On the left lateral side of the first screen 7a there is a second screen 7b which is in a peripheral display state, where areas of the process control system are shown as shapes in grey scale. On this screen there is also an object I, which the user may need to pay attention to. On the right lateral side of the first screen 7a there is a third screen 7c which is also in a peripheral display state where grey scale is used.

In order to determine which screen the user is focused on, a movement determining system is used. The movement determining system may be a head orientation determining system. It may more particularly be a gaze tracking system. A gaze tracking system is sometimes known as an eye tracking system. The gaze tracking system may comprise one gaze tracking device per screen. The first screen 7a is thus equipped with a first gaze tracking device 11a, the second screen 7b is equipped with a second gaze tracking device 11b and the third screen 7c is equipped with a third gaze tracking device 11c. A gaze tracking device may be a device that detects the eye movement of the operator that looks at the corresponding screen and may for instance be a device employing the eye tracking techniques of Tobii Technology or Smart Eye. As an alternative it is possible that a gaze tracking device covers more than one screen.

The gaze tracking devices communicate with the display control unit, which may then determine which screen the user is focusing on and perhaps even which part or region of a screen that the operator is looking at. It may more particularly determine if head movements have been made by the operator in the direction of a certain screen.

There are other ways in which an operator movement may be determined than using a gaze tracking system. One way is to equip the operator with special glasses 17 that includes a tag reader, such as a bar code reader or Radio Frequency Identification (RFID) reader, capable of reading a tag or marker 18 on a screen. One example of this is shown in FIG. 2. One possible realization of such a system is to use Microsoft HoloLens that can do marker recognition on the fly and as such detect at which screen the user is looking at a particular moment. This tag reader may then communicate with the display control unit employing a WiFi or Bluetooth connection or some other technology. As an alternative it is possible that tag readers are placed on the screens and the user is equipped with a tag. A tag reader then detects a tag and informs the display control unit, which is thereby informed about which screen the operator 13 is closest to. The screen corresponding to the tag that the user is closest to is then determined to be the screen towards which the head of the user is oriented. As can be seen in FIG. 2, the operator 13 may use a user interface device 15, here in the form of a mouse, the use of which may also be detected by the display control unit. The operator 13 may additionally be at a distance D from the workstation and in this case also from the first screen 7a, which distance D may be detected using a tag reader, a gaze detecting system or some other suitable distance determining system, such as Bluetooth.

Other techniques that may be used for determining operator movement include Ultrawide band (UWB) (used in hospitals for tracking doctors), Infrared (IR), Gen2IR, Visible light communication and Ultrasound.

It is possible that focal and peripheral display states are always used in the workstation. However, it is also possible that this functionality is selectively used.

The screens of the workstation may therefore initially operate in a regular display mode, where all screens display a maximum amount of information that is adapted to the focal viewing capability of the operator 13. In this regular display mode all screens thus display information corresponding to the focal display state and full colours. From this regular display mode it is possible to enter into a focus display mode, where one screen operates as focal screen where details that may be viewed focally are displayed in detail and full colours and one or more of the rest of the screens are peripheral screens where less detail and less colours are being shown. Thereby the operator may be aided in the focusing on a task without being distracted, which may be important in many process control systems.

However, it may not always be desirable to enter into the focal display mode. At times the user may need to look between the different displays in order to determine a certain course of action. If then these constantly change display modes, this fact may in fact be a distraction to the operator.

There may therefore also be a need for determining that the user is actually focused on a screen and that he or she would be aided of the workstation system operating in a focus display mode.

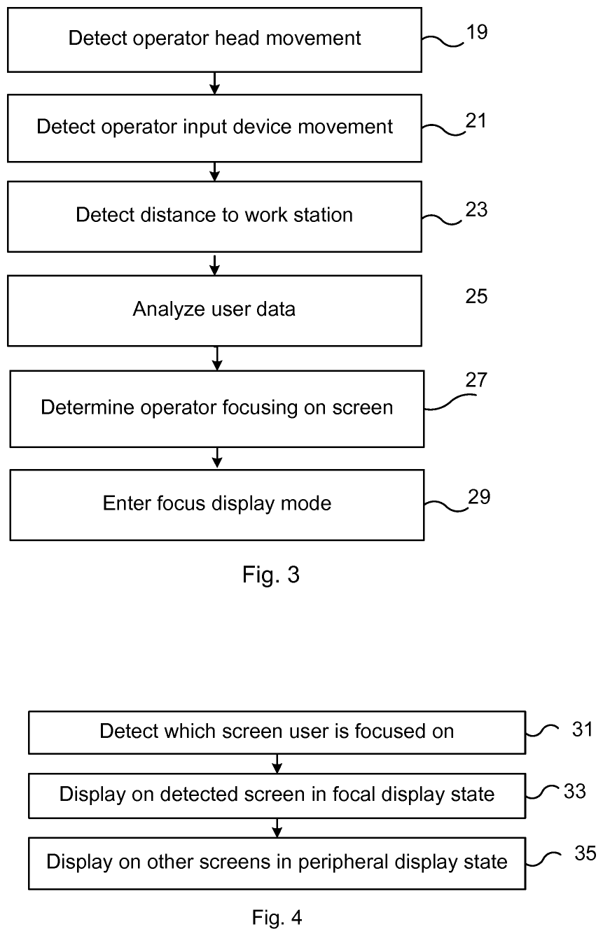

How this determination may be done will now also be described with reference being made to FIG. 3, which shows a flow chart of a number of method steps used for entering into a focus display mode, where focal and peripheral display states are used.

The method may comprise the display control unit obtaining of user data, which user data may comprise one or more of head movement data, user input device data and distance data. In order to obtain the user data, the movement determining system may detect operator head movement, step 19, which may be done using the gaze tracking system. Also user input device movement may be detected, step 21, which in the case of FIG. 2 may be the detection of the movement of the mouse. This detection may be made through regular user interface control functionality of the workstation informing the display control function that the user interface device is being used. The detection may additionally involve detecting the distance between the operator and the workstation, step 23, which may again be done through the gaze detecting system detecting the distance between the operator 13 and a gaze detecting device and reporting this distance D to the display control unit. All this data is user data that is used to determine if the focal display mode is to be entered or not.

After having obtained this user data the display control function analyses the user data, step 25, and determines whether a focus display mode is to be entered or not. The analysis may involve determining that head movements are made in the direction towards the first screen 7a and also determining the time that these head movements are being made. If a determination is being made that the focus display mode is to be entered, the focus display mode is then entered, step 29, which thus involves making one screen into a focal screen and at least some of the other screens into peripheral screens. It more particularly involves making the screen that the operator is focusing on to have the folia display state and at least one other screen to have the peripheral display state.

The determination may involve investigating the detected gaze of the operator on a screen. The display control unit thus analyses the data of operator head movements, analysing the detected time and/or analysing the detected distance. If for instance the user has looked at a screen during a time that exceeds a time threshold indicating operator concentration, then it is possible that a decision is made to enter the focal display mode. Here it is also possible to consider if the gaze of the user wanders around on the screen or not. It is for instance possible that the user has to gaze at the same area or region R of the screen for a time exceeding the time threshold in order for the focus display mode to be entered.

It is likewise possible that operator inputs made via the mouse are considered. A gazing at the region R together with actuation of the user input device 15 may as an example be an indication of concentration, while a gaze without such actuation may not.

It is likewise possible that the distance D between the operator and the screen is a factor. It may for instance only be possible to enter the focus display mode in case the distance D to any of the screens is below a distance threshold. This means that in one variation the focal display mode may only be entered in case the distance D is below the distance threshold and the user gazes at the section or region R a time exceeding the time threshold while at the same time using the user input device 15.

Once the focal display mode has been entered, the display control unit then makes one screen into a focal screen and at least some of the rest of the screens into peripheral screens. It is here possible that screens laterally oriented in relation to focal screens are made into peripheral screens. Thereby the display control unit sets the focal screen to operate in a focal display state and the peripheral screens to operate in a peripheral display state.

Which screen is to be made into a focal screen may then involve detecting a which of the plurality of screens the operator 13 is focused on, step 31, where the screen on which the operator 13 is focused is a first screen 7a having a focal display state and a least a second screen 7b of the remaining screens has a peripheral display state. The detection may be done using the gaze detecting system. The screen that the user gazes on is thus made into a focal screen, where displaying is made in the focal display state, step 33, and the other screens are being made into peripheral screens, where displaying is made in the peripheral display state, step 35. In the example in FIG. 1, the first screen 7a is made into a focal screen, while the second and third lateral screens 7b and 7c are made into peripheral screens. The information being displayed on the first screen 7a is then displayed with a high degree of detail in the focal display state, while the information in the other displays are displayed with a lower degree of detail in the peripheral display state than the focal display state. It can thereby be seen that the first screen initially has the focal display state and the second screen 7b initially has the peripheral display state.

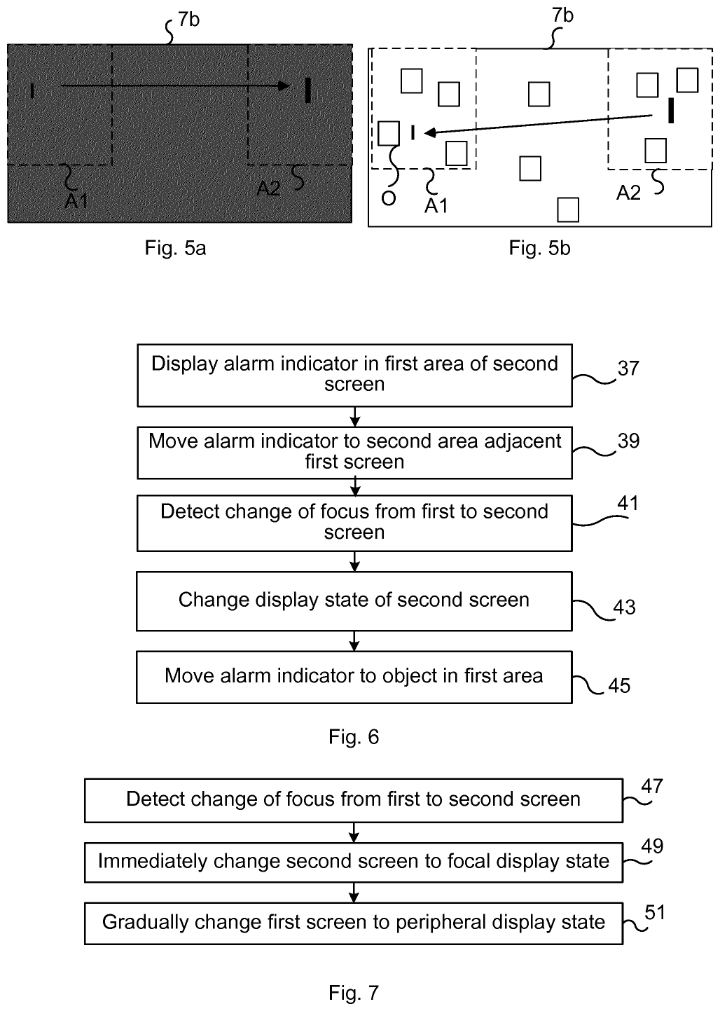

When the first screen 7a initially has the focal display state and the second screen 7b initially has the peripheral display state, it is possible that, as can be seen in FIG. 1, an object I on the second screen 7b may need the attention from the operator 13. This object I may be an indicator of an alarm generated in the process control system. Such an indicator may be difficult for the operator to notice in case it occurs in his or her peripheral view. How this may be handled will now be described with reference being ,made to FIGS. 5a, 5b and 6, where FIGS. 5a and 5b show the occurrence of the alarm in a first area A1 of the second screen 7a, the displaying of the alarm indicator I in a first and second area A1 and A2 of the second screen 7b when in a peripheral and a focal state, while FIG. 6 schematically shows a number of method steps in the focus display mode for the displaying of the alarm indicator in the second screen 7b.

When the second screen 7b is a peripheral screen an alarm may occur or be generated for an object O in the process control system, which object is located in a first area Al of the screen 7b when in the regular display mode or the focal display state. However, the object O may be invisible in the peripheral display state. The first area A1 may additionally be limited to the object or a group of objects displayed in a regular display mode or the focal display state. The first area A1 may also be a section of the second screen 7b without any linking to any object grouping except for the fact that the object O would be displayed there when the second screen 7b is a focal screen or the system is in the regular display mode. Upon the generation of the alarm, an alarm indicator I is, as can be seen in FIG. 5a, displayed in the first area A1, step 37. In order to enable the operator to notice the alarm, the alarm indicator I or alarm representation is then moved to a second area A2 adjacent the first screen 7a in order for the indicator to be displayed in the second area A2. It is thus moved to an area of the peripheral screen adjacent the current focal screen, step 39. This movement may be a gradual movement or it may be immediate. The indicator I may at the same time be actuated to improve its noticeability. It may for instance be blinking, highlighted and/or be enlarged, where all these measures are made in order for the operator to notice the alarm. In FIGS. 5a and 5b this is indicated through the indicator I having its size changed.

When the operator notices the alarm and thereby moves his or her focus from the first screen 7a to the second screen 7b, the change of focus is detected by the display control unit, step 41, based on the first gaze detecting device 11a losing contact with the eye of the user 13, i.e. being unable to track the gaze, and the second gaze detecting device 11b obtaining contact with the eye of the user 13, i.e. being able to track the gaze. This information may be supplied by the gaze tracking devices as gaze tracking device events, to which the display control unit may subscribe. On the appropriate event received (i.e. when a screen is losing/obtaining the operator's focus), the process graphics rendered on that screen should change according to the state of the screen. The display control unit then changes the display states. The display state of the first screen 7a is then changed from the focal display state to the peripheral display state based on the detection of change of focus. More importantly though, the display state of the second screen 7b is now also changed from the peripheral display state to the focal display state based on the detection of change of focus, step 43, which is shown in FIG. 5b.

In the focal display state, the second screen 7b has a number of more details being shown compared with before the state change. In order to better know for which object the alarm was generated, the alarm indicator I is now moved to the object O for which it was generated, which object is thus located in the first area A1. This movement is thus made after the detection of a change of focus. This object O may not have been visible when the second screen 7b had the peripheral display state. Moreover, the movement may be a gradual movement in order for the operator not to lose sight of the alarm indicator I.

Through the movement of the indicator I to the second area A2, it is in this way ensured that the operator 13 is being informed about the alarm. Through moving it back to the first area A1 and more particularly to the now displayed object O for which the alarm was generated, it is also ensured that the operator 13 can link the alarm to this object O and therefore perform the appropriate activities for handling of the alarm.

In the change of the second screen 7b from the peripheral display state to the focal display state, the change is typically made immediately when the user changes his or her attention to the second screen 7b. At the same time the first screen 7a changes from the focal to the peripheral display state. However, this change is typically carried out gradually, which may be a gradual change over time. The gradual change may be finished within a time range of 20-90 s and with advantage within a range of 30-60 s after the state change has been initiated.

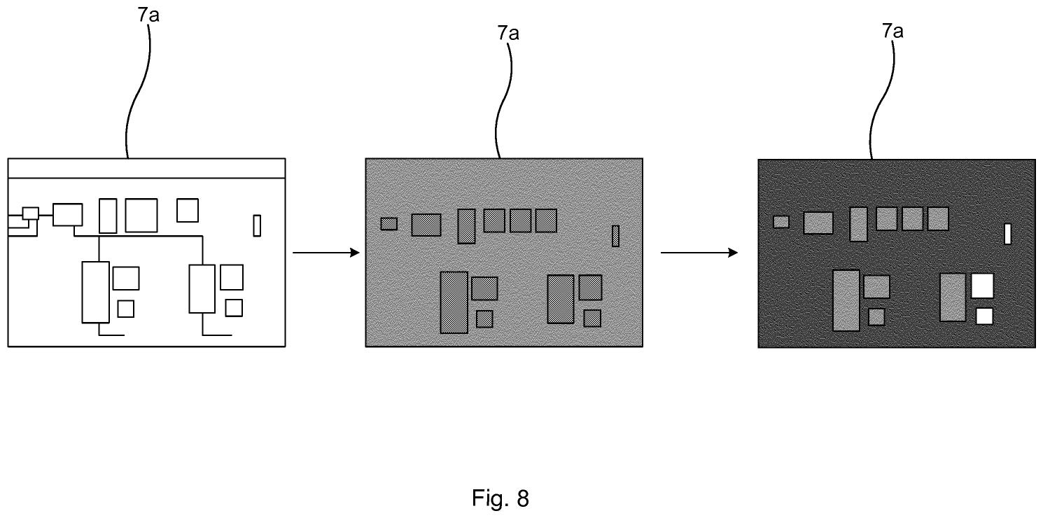

How this may be done will now be further described with reference being made to FIGS. 7 and 8, where FIG. 7 schematically shows a number of method steps in the focus display mode for changing the first screen to operate in a peripheral display and change the second screen to operate in the focal display state, and FIG. 8 shows the gradual change of the first screen when turning into a peripheral screen, i.e. when obtaining the peripheral display state.

The display control unit thus detects the change of focus from the first to the second screen, step 47, which may be done through the first gaze tracking device 11a being unable to track the gaze of the operator to the second gaze tracking device 11b being able to track the gaze of the operator 13. When this happens the state of the second screen 7b is immediately changed from peripheral to focal, step 49. However the state of the first screen 7a is only gradually changed from focal to peripheral, step 51.

The change into a peripheral display state may again include forming the objects into clusters and changing the colour into grey scale, which is exemplified in FIG. 8.

The transition between the process graphics representation from focal to peripheral may thus be implemented in a soft manner, e.g. through slow fading of the colored and detailed process graphics into simplified gray scale. On contrary, when the screen gets the attention, the switch may be immediate.

The immediate change to the focal display may be important because in a process control system, the operator may need to quickly see the objects that may be of interest to her or him for resolving an issue. This may especially be important when the user is about to handle an alarm. However, it may also be important that the new peripheral screen is changed gradually.

As was stated above the peripheral vision of humans is sensitive to changes. In case the change is abrupt, the operator may thus observe the change in the corner of his or her eye. If this happens abruptly when the first screen turns into a peripheral screen, the operator may react through turning back to the first screen, which would then again become a focal screen. It can be seen that through this the operator may be subjected to abrupt changes of the screen that may form a distraction. If instead the change is gradual over time, such as over a number of seconds, then there are no abrupt changes and the operator can better focus on the task at hand in the second screen.

Particular design approach how a process graphics view should look in the peripheral display state can vary from implementation to implementation. However, some of the ideas presented here are the following:
1. Simplify the shapes. Omit the details. Remove texts and numbers.
2. Keep the view in gray scale. The darker the objects the less attention they attract, the brighter the objects the more visible they are.
3. Attract the user's attention using flickering (i.e. changing the brightness of the object from gray to white) or by motion, e.g. moving the object closer towards the focal area of the user.

It is furthermore possible for the user to adjust the sensitivity of the peripheral view. The user may thus set the level at which any change, and especially any critical change, occurs in the process control system, is to be signalled for example when an alarm occurs.

The provision of the view used in a peripheral display state may be implemented in a simple fashion without changing the displaying functionality used in the regular display mode. It is for instance possible to take a screen shot of a screen of the focal display state or of the regular display mode and then process the screen shot, such as changing the colour and forming of clusters out of objects. In case a gradual change is to be made, a number of screen shot copies may then be processed slightly differently from each other in order to obtain a number of views to be displayed in a time sequence, where the copy associated with a time has a change in colour and clustering in a number of steps from the focal view to the fully peripheral view. Such processed screen shots may then be overlaid on the focal view at different points in time until the last screen shot is reached, which remains overlaid until the screen again changes state or the focal display mode is exited.

It is thereby a simple task to exit the peripheral display state for the focal display state or the regular display mode through merely removing the overlaid screen shot.

As an alternative it is possible that the transparency of the overlaid peripheral view is gradually increased in order to gradually fade away as original view is being made into the focal view.

Another variation that is possible to make is that the plurality of screens are part of a common display. A screen may thus be a dedicated area of this display. In this way multiple screens are embodied as multiple dedicated areas on one very large display, which display may for instance covering a wall or a part of a wall in a control room.

The invention has a number of further advantages in addition to those already mentioned. It allows the control system to become more reliable, as the operator is less likely to miss important information even if he/she is not focusing his/her attention on a particular screen. It will increase alertness and situational awareness of the operators. Interaction with process control system will potentially become less error prone due to human factor.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of facilitating operator concentration on one of a plurality of operator workstation screens of a control and monitoring system, wherein the method is performed by the control and monitoring system and comprises:
detecting which of the plurality of screens that an operator is focused on, where the screen on which the operator is focused is a first screen,
displaying information on the first screen in a focal display state with a high degree of detail,
displaying information on at least a second screen, which is different from the first screen, in a peripheral display state with a lower degree of detail than the focal display state.
detecting a change of focus by the operator from the first screen to the second screen, where the first screen initially has the focal display state and the second screen initially has the peripheral display state,
changing the state of the second screen from the peripheral display state to the focal display state based on the detection of change of focus, and
changing the state of the first screen from the focal display state to the peripheral display state based on the detection of change of focus,
wherein the changing of the state of the second screen from the peripheral display state to the focal display state is made directly after the detection of change of focus and the changing of the state of the first screen from the focal display state to the peripheral display state is made gradually after the detection of change of focus.

2. (canceled)

3. (canceled)

4. The method according to claim 1, wherein the gradual change is finished within a time in a range of 20-90 s, and with advantage in a range of 30-60 s, after being initiated.

5. The method as claimed in claim 1, wherein an object displayed in a first area of the second screen is a process control object for which alarms can be generated, and further comprising displaying, upon the generation of an alarm for said object when the second screen has the peripheral display state, a visual indicator of said alarm in a second area of the second screen adjacent the first screen, detecting said change of focus from the first to the second screen and moving the indicator of the alarm to the corresponding object displayed in the first area of the second screen after the detection of change of focus.

6. The method as claimed in claim 5, wherein the moving of the indicator comprises gradually moving the visual indicator of said alarm across the second screen from the second area to the first area.

7. The method according to claim 5, further comprising initially displaying the indicator in the first area of the second screen and moving it to the second area for said displaying.

8. The method as claimed in claim 1, wherein the focal display state and peripheral display state are employed when the control and monitoring system is operating in a focus display mode, and further comprising detecting movements of the operator, analysing user data comprising data of operator movements, determining that the operator is focusing on a screen based on the analysis and entering the focus display mode based on the analysis, in which focus display mode the screen that the operator focuses on has the focal display state and at least one other screen has the peripheral display state.

9. The method as claimed in claim 8, further comprising detecting the time during which movements are made in the direction towards the first screen and the analysing comprises analysing the detected time.

10. The method as claimed in claim 8, further comprising detecting movement of a user interface device and the analysing comprises analysing the detected user interface device movement.

11. The method as claimed in claim 8, wherein the detected movements of the operator are head movements and further comprising detecting the distance between the operator and at least one of the plurality of operator workstation screens and the analysing comprises analysing also the detected distance.

12. The method according to claim 1, wherein the displaying in the focal display state comprises displaying using a set of colours and the displaying in the peripheral display state comprises displaying using grey scale.

13. The method according to claim 1, wherein the displaying in the focal display state comprises displaying using a first colour scale and the displaying in the peripheral display state comprises displaying using a second colour scale.

14. A computer program comprising computer code which when executed by processing circuitry of a control and monitoring system causes the control and monitoring system to perform the steps of a method including:
detect which of a plurality of operator workstation screens that an operator is focused on, where the screen on which the operator is focused is a first screen,
set the first screen to display information in a focal display state with a high degree of detail,
set at least a second screen, which is different from the first screen, to display information in a peripheral display state with a lower degree of detail than the focal display state,
detect a change of focus by the operator from the first screen to the second screen, where the first screen initially has the focal display state and the second screen initially has the peripheral display state,
change the state of the second screen from the peripheral display state to the focal display state based on the detection of change of focus, and
change the state of the first screen from the focal display state to the peripheral display state based on the detection of change of focus,
wherein the change of the state of the second screen from the peripheral display state to the focal display state is made directly after the detection of change of focus and the change of the state of the first screen from the focal display state to the peripheral display state is made gradually after the detection of change of focus.

15. A control and monitoring system comprising:
a plurality of operator workstation screens,
a storage medium comprising computer code,
a head orientation determining system and
processing circuitry which when executing the computer code causes the control and monitoring system to
detect which of the plurality of screens that an operator is focused on, where the screen on which the operator is focused is a first screen,
set the first screen to display information in a focal display state with a high degree of detail,
set at least a second screen, which is different from the first screen, to display information in a peripheral display state with a lower degree of detail than the focal display state,
detect a change of focus by the operator from the first screen to the second screen, where the first screen initially has the focal display state and the second screen initially has the peripheral display state,
change the state of the second screen from the peripheral display state to the focal display state based on the detection of change of focus, and
change the state of the first screen from the focal display state to the peripheral display state based on the detection of change of focus,
wherein the change of the state of the second screen from the peripheral display state to the focal display state is made directly after the detection of change of focus and the change of the state of the first screen from the focal display state to the peripheral display state is made gradually after the detection of change of focus.
